(19) United States
(12) Patent Application Publication
(10) Pub. No.: US 2016/0110678 A1
(43) Pub. Date: Apr. 21, 2016

(54) Methods and Systems for Dynamic Selection and Delivery of Relevant Products

(71) Applicant: COX COMMUNICATIONS, INC., Atlanta, GA (US)

(72) Inventors: Todd Lane, Atlanta, GA (US); Nadine Finnerty, Atlanta, GA (US); Dipan Patel, Atlanta, GA (US)

(21) Appl. No.: 14/516,022

(22) Filed: Oct. 16, 2014

(51) Int. Cl. G06Q 10/08; G06Q 50/00; H04L 29/08

(52) U.S. Cl. CPC G06Q 10/083; H04L 67/306; G06Q 50/01

(57) ABSTRACT

Methods and systems for dynamic selection and delivery of relevant products are disclosed. The method may include receiving consumer profile information, monitoring consumer activity, and identifying a first lifecycle event completed by the consumer based at least in part on the consumer activity. The method may include updating the consumer profile information based at least in part on the identified first lifecycle event, determining a consumer category for the consumer, and selecting a first set of items to send to the consumer, based at least in part on the updated consumer profile information and the consumer category. The method may include triggering a first shipment of the first set of items to the consumer, and automatically triggering a second shipment of the second set of items to the consumer, wherein the second shipment is sent after a predetermined amount of time has elapsed since the first shipment.

### TECHNICAL FIELD

This disclosure generally relates to delivery of relevant products, and more particularly automatically delivering products relevant to specific recipients.

### BACKGROUND

Modern consumers may be educated, technologically connected, and may lead busy lives. Consumers may appreciate certain conveniences associated with modern technology. For example, consumers may receive monthly shipments of products as part of a subscription service. However, consumers may have needs or desires that change over time. Additionally, as consumers complete life milestones or other meaningful accomplishments, consumers may not be fully prepared or informed regarding recommended follow up actions upon completion or expected completion of the life milestones or other accomplishments. Accordingly, methods and systems for dynamic selection and delivery of relevant products may be desired.

### BRIEF DESCRIPTION OF THE FIGURES

Reference will now be made to the accompanying drawings, which are not necessarily drawn to scale, and wherein:

FIG. 1 is a simplified schematic illustration of a product curation system, in accordance with certain example embodiments of the disclosure.

FIG. 2 is a simplified block diagram of the product curation system of FIG. 1, in accordance with certain example embodiments of the disclosure.

FIG. 3 is a flow diagram illustrating an example method for dynamic selection and delivery of relevant products, in accordance with certain example embodiments of the disclosure.

FIG. 4 is a simplified schematic illustration of a user interface and example relevant product selection for a product curation system, in accordance with certain example embodiments of the disclosure.

FIG. 5 is a simplified schematic illustration of additional embodiments of relevant product selection for a product curation system, in accordance with certain example embodiments of the disclosure.

### DETAILED DESCRIPTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

Example embodiments of the disclosure may provide systems, apparatus, non-transitory computer readable media, and methods for selecting relevant products for delivery to particular consumers. Relevant products may include products that are relevant to a consumer at particular times in the consumer's life. Products may be selected from, for example, household items, healthcare items, nutritional supplements, tools and other hardware, clothing items, gifts, informational resources, and other products that may be used or otherwise consumed by consumers as described herein. In the systems and methods described herein, consumers may be associated with consumer profiles. Consumer profiles may include consumer information, such as demographic information, geographic information, social contact information (e.g., social media information, friends, acquaintances, colleagues, etc.), and/or additional information related to the consumer as discussed herein. Consumer profiles may be associated with consumer activity. Consumer activity may include a purchase history or recent transactions completed by a consumer, products a consumer wishes to receive (e.g., a “wishlist” items), internet search history, and the like. The consumer activity may be associated with specific consumers via the consumer profile.

The systems and methods described herein may identify lifecycle events completed by consumers, as well as lifecycle events that consumers may soon complete. Lifecycle events may be actions or events that represent milestones, achievements, goals, accomplishments, and the like that are either generally understood, such as graduating from high school or college, or that are specific to particular consumers, such as a weight loss goal of ten pounds. Additional examples of lifecycle events or actions include birthdays, anniversaries, graduations, weddings, births of children, major acquisitions or purchases, and the like.

Completion of lifecycle events may be identified based at least in part on consumer activity. Upon completion of a lifecycle event by a consumer, the systems and methods described herein may update the appropriate consumer profile and generate an updated consumer profile. The consumer may be categorized based at least in part on the updated consumer profile. Consumer categories may be separated into different categories including, but not limited to, age based categories, life stage based categories (e.g., new homeowner, first time parent, etc.), demographic categories, and the like. For example, a consumer that recently completed a lifecycle event of graduating from college may be placed in a “new job” consumer category, and if that consumer also recently bought a car, the consumer may also be placed in a “first time car owner” consumer category. Consumers may be categorized in multiple consumer categories.

Relevant products may be selected for delivery to the consumer based at least in part on the consumer categories and/or the updated consumer profile information associated with the consumer. The relevant products may be a set of products or items that are relevant to consumers in certain consumer categories generally, or to specific consumers. For example, some consumers may have been determined to be cost-conscious, while other consumers may have been determined to be loyal to certain brands or may be willing to pay a premium for higher quality. Accordingly, the set of items may include certain brand name products, or the cheapest possible product regardless of the brand name, based at least in part on the consumer category of the consumer, for example.

A shipment of the set of relevant products, or items selected for the consumer, may be triggered. The shipment may subsequently be delivered to the consumer. In some embodiments, the shipment may be triggered before the consumer has requested the shipment. In such embodiments, the automatic shipment and subsequent delivery of the relevant products may allow the consumer to have the relevant products before or as they are needed by the consumer. In other embodiments, the consumer may request shipment of relevant products either periodically or on demand.

Upon shipment of the set of items, the systems and methods described herein may select a second set of items to send to the consumer. The selection of the second set of items may be at a point in time after shipment of the first set of items. In some embodiments, the selection of the second set of items may be based at least in part on the first set of items and an elapsed time from the first shipment. For example, the first set of items may have included diapers for a 3-month-old baby, and after a period of 3 months, the second set of items may include diapers for a 6-month-old baby instead of the previously selected diapers for a 3-month-old baby. Selection of the second set of items may be based at least in part on a prediction of a lifecycle event that will be completed by the consumer. For example, if a consumer's purchase history indicates that a crib was recently purchased, the selection of the second set of items may be based at least in part on a prediction that the consumer will soon complete a lifecycle event of having a baby.

The systems and methods described herein may further consider geographic information in determining relevant products for consumers. For example, if a consumer's neighbor recently received a blue shirt as part of a clothing kit or lifecycle kit, the systems and methods described herein may select an alternate color shirt for shipment to the consumer, such that the neighbors do not have identical or highly similar clothing.

The dynamic selection of relevant products to include in shipments to consumers may be automatically implemented by the systems and methods described herein and may allow consumers to receive kits or shipments that include products that are relevant to the consumer. In some embodiments, the kits or shipments may be relevant to the consumer's daily life, or to the consumer's life stage in general. In some embodiments, shipment of relevant products may be automatically triggered prior to customer initiation of a shipment, while in other embodiments, shipment of relevant products may be triggered by customer input or initiation.

It will be appreciated that in example embodiments, the methods and systems described herein may provide for identification of relevant products for particular consumers, selection of sets of items for shipment to the consumer, and automatic shipment of the selected items to the consumer. The shipments may provide the consumer with products that benefit the consumer's daily life. Curation of the items for shipments may be based on lifecycle events completed by the consumer, or predicted lifecycle events that will be completed by the consumer.

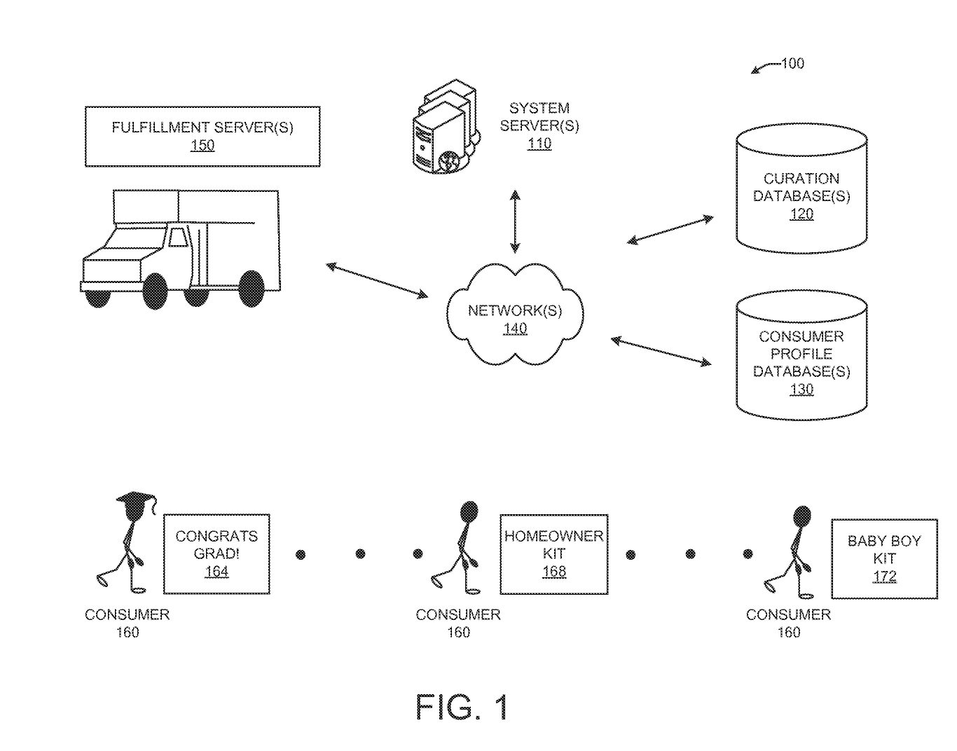

Some example elements involved in the operation of the methods, systems, and apparatuses disclosed herein may be better understood with reference to the figures. Referring to FIG. 1, an example product curation system 100 in accordance with embodiments of the disclosure is depicted. In the illustrated embodiment, the product curation system 100 includes a system server 110 in wired or wireless communication with one or more curation database(s) 120 and one or more consumer profile database(s) 130 via one or more network(s) 140. In some embodiments, the curation database(s) 120 and the consumer profile database(s) 130 may be stored at or otherwise locally accessible by the system server 110. The system server 110 may also be in communication with a fulfillment server 150 via the one or more network(s) 140. The fulfillment server 150 may be remotely located, for example at a distribution or fulfillment center. In other embodiments of the present disclosure, additional or fewer components may be included in the system 100.

The curation database(s) 120 may include one or more databases with information related to products, inventory, historical shipments, product ratings, and other information as described herein. The consumer profile database(s) 130 may include one or more databases with information related to particular consumers, consumer category information, and related information as described herein. The fulfillment server 150 may be configured to receive shipment information, for example from the system server 110, and may be configured to route shipments to consumers for delivery.

Still referring to FIG. 1, in one example, a consumer 160 may be a senior in college at a first point in time 162. The consumer 160 may be associated with a consumer profile stored at the consumer profile database(s) 130 indicating that the consumer 160 is a 22 year old male, a senior in college in Colorado, and a finance major. The consumer profile may also include recent transactions or purchases engaged in by the consumer 160. For example, the consumer 160 may have recently purchased a cap and gown. The system server 110 may determine the consumer profile for the consumer 160, and may monitor consumer activity completed by the consumer 160. Based at least in part on the consumer activity, or purchase of a cap and gown by the consumer 160, the system server 110 may identify or predict that the consumer 160 is likely going to complete, or has already completed, a lifecycle event of college graduation. The system server 110 may update the consumer profile for the consumer 160 at the consumer database 130 to indicate that the consumer 160 is graduating from, or has graduated from, college. Based at least in part on the updated consumer profile, the system server 110 may determine that the consumer 160 should be placed in a recent college graduate consumer category, a cold weather climate consumer category, and a young male adult consumer category. The system server 110 may determine products that are relevant to the consumer 160 based at least in part on one or more of the consumer categories the consumer 160 is in, and/or on specific preferences of the consumer 160. To determine relevant products, the system server 110 may select items from the curation database(s) 120 based on available inventory, product ratings, and historical shipments to the consumer 160. For example, the system server 110 may curate a kit 164 for shipment for the consumer 160. In the kit 164, the system server 110 may select a set of items including professional long sleeve dress shirts and slacks because the consumer 160 may be beginning a new job, along with a gift certificate to a local restaurant to celebrate the consumer's recent graduation, a professional sweater vest for the cold climate, and a book regarding leadership. The system server 110 may trigger shipment of the kit 164 upon or before the consumer 160 graduates.

After an elapsed amount of time as the consumer 160 progresses in life, the consumer 160 may apply for a mortgage at a subsequent point in time 166. Based at least in part on this consumer activity, the system server 110 may predict that the consumer 160 may complete a lifecycle event of purchasing a home. The system server 110 may select a second set of relevant products and trigger a shipment of a new homeowner kit 168 of the relevant products to the consumer 160 at the consumer's new address. In one example, the new homeowner kit 168 may include a tile grout cleaner, a list of local home repair service providers, and smoke detector batteries, as well as other products relevant to a new homeowner. The second shipment may also include items based at least in part on the items in the first kit 164, such as new clothes.

The consumer 160 may, at a later point in time 170, engage in consumer activity indicating that the consumer 160 is going to have a child, for example by purchasing a crib and/or car seat. The system 100 may select items such as pacifiers and diapers to include in a baby boy kit 172 shipped to the consumer. The system 100 may further send additional shipments based on a predetermined amount of time that has passed from the first shipment of the baby boy kit 172. For example, after 3 months, another kit with larger sized diapers may be shipped to the consumer 160.

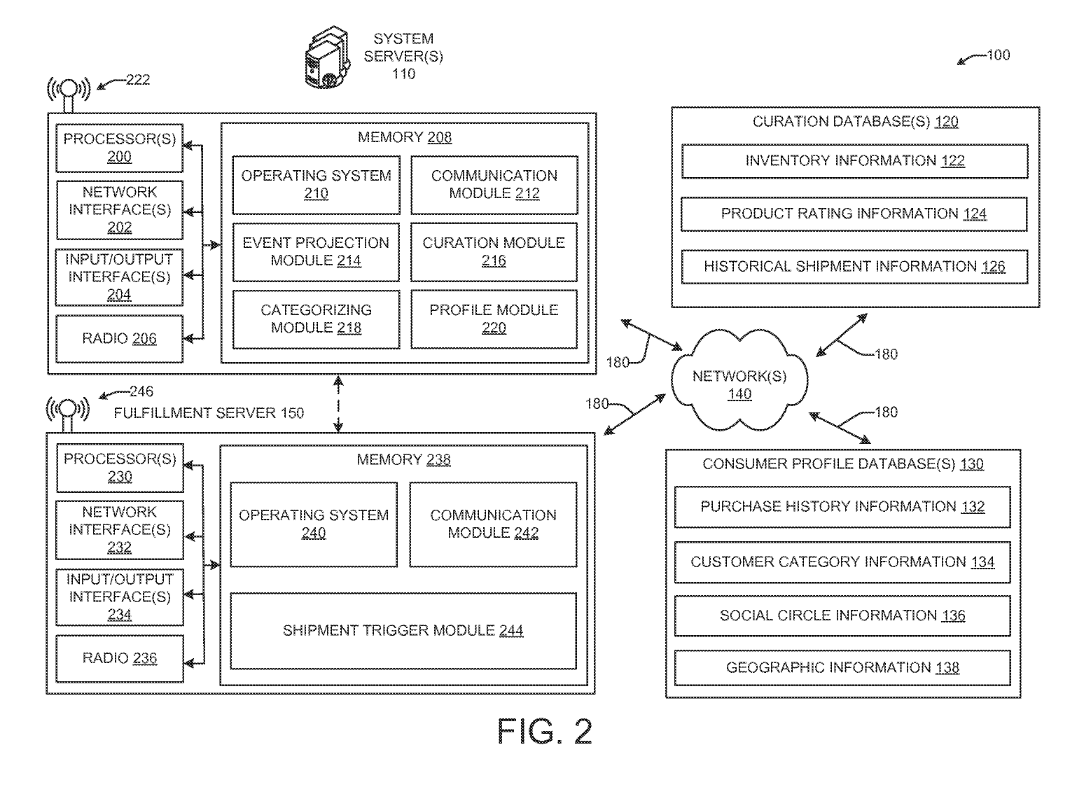

Referring now to FIG. 2, one embodiment of the product curation system 100 is schematically illustrated. The system server 110 may be in wireless communication 180 with the curation database(s) 120, the consumer profile database(s) 130, and the fulfillment server 150 via network(s) 140. In other embodiments, the product curation system 100 may include additional or fewer components.

In the illustrated embodiment, the system server 110 includes one or more processor(s) 200, one or more network interface(s) 202, one or more input/output interface(s) (I/O) 204, and a radio 206. Each component 200, 202, 204, 206 may be communicatively coupled to a memory 208. The memory 208 includes an operating system 210, a communication module 212, an event projection module 214, a curation module 216, a categorizing module 218, and a profile module 220. The system server 110 may include an antenna 222 in communication with the radio 206. The operating system 210 may provide users with a guided user interface and/or may provide software logic used to control the functions of the system server 110. The communication module 212 may be a mobile application stored on the memory 208 and may be configured to retrieve or determine information associated with the system server 110, as well as transmit and/or receive data from either or both of the system server 110 and the fulfillment server 150, as well as connected databases. The event projection module 214 may be configured to generate predictions of lifecycle events or actions that particular consumers may soon complete within a projected timeframe, or may have recently completed. The curation module 216 may interact with other modules or components of the system server 110 and/or the curation database(s) 120 and consumer profile database(s) 130 to select products or information that are relevant to specific consumers. The categorizing module 218 may interact with the consumer profile database(s) 130 to categorize consumers into one or more consumer categories. For example, the categorizing module 218 may be configured to determine geographic location information for consumers and categorize consumers into geographic categories such as by climate, region, neighborhood, and the like. The profile module 220 may be configured to create and/or update consumer profiles based on consumer activity and completion of lifecycle events. Although each of these components is shown in the illustrated embodiment, other embodiments may include additional or fewer components or modules.

The fulfillment server 150 includes one or more processor(s) 230, one or more network interface(s) 232, one or more input/output interface(s) (I/O) 234, and a radio 236. Each component 230, 232, 234, 236 may be communicatively coupled to a memory 238. The memory 238 includes an operating system 240, a communication module 242, and a shipment trigger module 244. The fulfillment server 150 may include an antenna 246 in communication with the radio 236. The operating system 240 may provide users with a guided user interface and/or may provide software logic used to control the functions of the fulfillment server 150. The communication module 242 may be configured to receive and/or transmit data to and from the fulfillment server 150 and/or system server 110, as well as connected databases. The shipment trigger module 244 may be configured to receive shipment information from the system server 110 and trigger shipments of selected items to consumers. Although each of these components is shown in the illustrated embodiment, other embodiments may include additional or fewer components or modules.

The system server 110 and the fulfillment server 150 may be any device configured to execute one or more applications, software, and/or instructions to provide one or more services to the product curation system 100. The system server 110 and/or the fulfillment server 150, as used herein, may be any variety of client devices, electronic devices, communication devices, and/or other user devices. The system server 110 and the fulfillment server 150 may include, but are not limited to, tablet computing devices, electronic book (eBook) readers, netbook computers, notebook computers, laptop computers, desktop computers, watches or other wearables, health monitors, personal digital assistants (PDAs), smartphones, web-enabled televisions, video game consoles, smart boards, set-top boxes (STBs), or the like. While the drawings and/or specification may portray the system server 110 and the fulfillment server 150 in the likeness of a server, the disclosure is not limited to such. Indeed, the methods and systems described herein may apply to any server, mobile device, or user device capable of communicating with other components of the product curation system 100.

Each respective processor 200, 230 of the system server 110 and the fulfillment server 150 may be implemented as appropriate in hardware, software, firmware, or combinations thereof. Software or firmware implementations of the processors 200, 230 may include computer-executable or machine-executable instructions written in any suitable programming language to perform the various functions described. Hardware implementations of the processors 200, 230 may be configured to execute computer-executable or machine-executable instructions to perform the various functions described. The processors 200, 230 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The system server 110 and/or the fulfillment server 150 may also include a chipset (not shown) for controlling communications between one or more processors 200, 230 and one or more of the other components of the system server 110 or the fulfillment server 150. The processors 200, 230 may also include one or more application-specific integrated circuits (ASICs) or application-specific standard products (ASSPs) for handling specific data processing functions or tasks.

The network interfaces(s) 202, 232 of the system server 110 and the fulfillment server 150 may allow the respective servers 110, 150 to communicate via the network(s) 140 and/or via other communicative channels. The servers 110, 150 may, therefore, be configured to access one or more remote servers, cloud servers, and/or cloud storage resources. The I/O interfaces 204, 234 included in the system server 110 and the fulfillment server 150 may enable the use of one or more user interfaces for receiving user input and/or providing output to the user. A user may be able to administer or manage the methods and systems disclosed herein by interacting with the system server 110 or the fulfillment server 150 via the I/O interfaces 204, 234, such as a touchscreen interface, a display, a guided user interface, or any other input/output interface. The I/O interfaces 204, 234 may be in the form of a touch screen, a microphone, an accelerometer sensor, a speaker, or any other suitable I/O interfaces 204, 234 that may be used by the user to interact with the system server 110 or the fulfillment server 150.

The memory 208 of the system server 110, as well as the memory 238 of the fulfillment server 150 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

Each respective memory 208, 238 may store program instructions that are loadable and executable on each respective processor 200, 230, as well as data generated or received during the execution of these programs. Turning to the contents of each memory 208, 238 in more detail, each memory 208, 238 may include several modules. Each of the modules and/or software may provide functionality for the system server 110 or the fulfillment server 150, when executed by the processors 200, 230. The modules and/or the software may or may not correspond to physical locations and/or addresses in each memory 208, 238. In other words, the contents of each of the modules may not be segregated from each other and may, in fact, be stored in at least partially interleaved positions on each memory 208, 238.

The memory 208, 238 of the respective system server 110 and the fulfillment server 150 may also include a respective operating system 210, 240. The processors 200, 230 of the system server 110 or the fulfillment server 150 may each be configured to access and execute one or more operating systems 210, 240 stored in the respective memory 208, 238 to operate the system functions of the electronic device. System functions, as managed by the respective operating system 210, 240, may include memory management, processor resource management, driver management, application software management, system configuration, and the like. The respective operating system 210, 240 may be any variety of suitable operating systems including, but not limited to, Google® Android®, Microsoft® Windows®, Microsoft® Windows® Server®, Linux, Apple® OS-X®, or the like.

The radios 206, 236 of the system server 110 and/or the fulfillment server 150 may be a transmit/receive component, such as a transceiver. The radio 206, 236 may include any suitable radio(s) and/or transceiver(s) for transmitting and/or receiving radio frequency (RF) signals in the bandwidth and/or channels corresponding to the communications protocols utilized by the fulfillment server 150 to communicate with each other or with other user devices and/or the system server 110 or another component of the product curation system 100. The radio 206, 236 may include hardware and/or software to modulate communications signals according to pre-established distribution protocols. The radio 206, 236 may further have hardware and/or software instructions to communicate via one or more Wi-Fi and/or Wi-Fi direct protocols, as standardized by the Institute of Electrical and Electronics Engineers (IEEE) 802.11 standards. In certain embodiments, the radio 206, 236, in cooperation with their respective antennas 222, 246, may be configured to communicate via 2.4 GHz channels (e.g., 802.11b, 802.11g, 802.11n), 5 GHz channels (e.g., 802.11n, 802.11ac), or 60 GHz channels (e.g., 802.11ad). In alternative embodiments, non-Wi-Fi protocols may be used for communications between the system server 110 and/or the fulfillment server 150, such as BLUETOOTH™, BLUETOOTH™ LE, Near Field Communication, dedicated short-range communication (DSRC), or other packetized radio communications. The radio 206, 236 may include any known receiver and baseband suitable for communicating via the communications protocols of the system server 110 and/or the fulfillment server 150. The radio 206, 236 may further include a low noise amplifier (LNA), additional signal amplifiers, an analog-to-digital (A/D) converter, one or more buffers, and a digital baseband.

The antenna 222, 246 included in the system server 110 and the respective fulfillment server 150 may be configured for receiving and/or transmitting communications signals from/to each other or other components of the product curation system 100. The antennas 222, 246 may be any suitable type of antenna corresponding to the communications protocols used by the system server 110 and/or the fulfillment server 150 for the particular signals received and/or transmitted via the antennas 222, 246. Some non-limiting examples of suitable antennas 222, 246 include directional antennas, non-directional antennas, dipole antennas, folded dipole antennas, patch antennas, multiple-input multiple-output (MIMO) antennas, or the like. Each antenna 222, 246 may be communicatively coupled to a radio component to transmit and/or receive signals, such as communications signals, to and/or from the system server 110 and/or the fulfillment server 150.

The antennas 222, 246 may be configured to receive and/or transmit signals in accordance with established standards and protocols, such as Institute of Electrical and Electronics Engineers (IEEE) 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antennas 222, 246 may be configured to receive and/or transmit non-Wi-Fi protocol signals, such as BLUETOOTH™, BLUETOOTH™ LE, Near Field Communication, dedicated short-range communication (DSRC), or other packetized radio communications.

The curation database(s) 120 and the consumer profile database(s) 130 may be remotely or locally stored, for example at a remote server or on the memory 208 of the system server 110. The respective databases 120, 130 may provide non-volatile storage of computer-executable instructions and other data. The respective databases 120, 130 may be removable and/or non-removable, and are examples of computer-readable storage media (CRSM) as that term is used herein. The respective databases 120, 130 may store computer-executable code, instructions, or the like that may be loadable into the memory 160 and executable by the processor(s) 200, 230 of the system server 110 and/or the fulfillment server 150 to cause the respective processor(s) 200, 230 to perform or initiate various operations. The respective databases 120, 130 may additionally store data that may be copied to memory 208, 238 for use by the processor(s) 200, 230 during the execution of the computer-executable instructions. The respective databases 120, 130 may store data persistently or temporarily.

The curation database(s) 120 may include inventory information 122, product rating information 124, and historical shipment information 126. Inventory information 122 may include information regarding a current available inventory at fulfillment centers from which shipments to consumers can be made. The inventory information 122 may include data regarding items returned by or otherwise identified as undesirable by certain consumers. Product rating information 124 may include overall ratings of products provided by consumers that have received the products. Product rating information 124 may also include data from external sources, such as online feedback portals, merchant websites, and the like. Historical shipment information 126 may include data regarding previous shipments to consumers. Historical shipment information 126 may be analyzed to compare shipment contents to shipments sent to known associates of consumers.

The consumer profile database(s) 130 may include consumer profile information, such as purchase history information 132, consumer category information 134, social circle information 136, and geographic information 138. Purchase history information 132 may include data related to recent purchases or orders placed by specific consumer. Such information may be obtained from credit card transactions or authorizations, internet history, bank account information, and the like. Purchase history information 132 may be used to determine spend tendencies of consumers. In some embodiments, spend tendencies may also be determined based on social circle information 136 and geographic information 138, to determine if the consumer is cost conscious or premium focused. Purchase history information 132 may include payment history indicative of a consumer's credit or trustworthiness. For example, if a consumer is timely with payments, the consumer may be more trustworthy in accepting higher dollar items or products. Consumer category information 134 may include data regarding specific consumer categories, as well as consumers associated with each of the consumer categories. The consumer category may include an expected spend rating or an impulsiveness rating for specific consumers.

Social circle information 136 may include data regarding other consumers in a specific consumer's social circle. Social circle information 136 may include social media account login credentials, information collected from social media accounts, work colleagues, family members, professional contacts information, and other known associates of a particular consumer.

Geographic information 138 may include a residential region for consumers, preferred travel destinations, average home values, school districts, and other geographic information. Different geographic regions may have different cultures or preferences. Geographic information may include geographic information for social contacts of the consumer.

Consumer profile information may include information related to consumer habits. For example, an average amount of time spent watching television may be included in the consumer profile information. The average amount of time spent watching television may be subdivided into discrete portions, such as weeknight watching and weekend watching. Such information related to consumer habits may be used to categorize the consumer. In one example, a consumer that spends a significant amount of time watching television may be a stay at home mom, or may be retired. A consumer with a relatively expensive cable television package may have a relatively higher amount of disposable income. The television content viewed by the consumer may also be included in the consumer profile information. The television content information may be analyzed and used to place the consumer in a consumer category. For example, if 90% of a consumer's television consumption is sports related, the consumer may be a sports fanatic. In another example, if the consumer watches cartoons, the consumer may have small children.

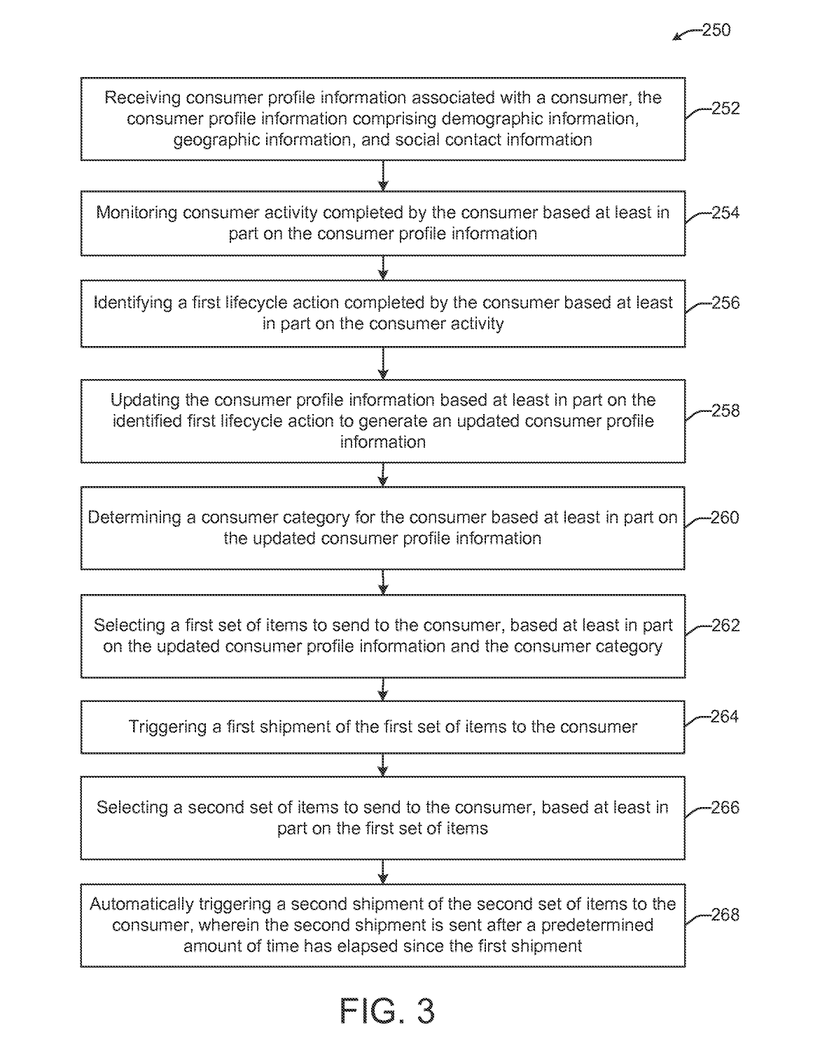

Referring now to FIG. 3, an example method 250 for dynamic selection and delivery of relevant products according to one embodiment of the disclosure is illustrated. The method 250 may be performed by a system having features disclosed herein, for example, the product curation system 100, or more specifically in certain embodiments, the system server 110 of FIG. 1. Block 252 of the method 250 includes receiving consumer profile information associated with a consumer, the consumer profile information comprising demographic information, geographic information, and social contact information. For example, the system server 110 may receive consumer profile information from the consumer profile database(s) 130 in FIG. 1. The consumer profile information may indicate that the consumer is a 60 year old male that has a basic high speed internet connection and accesses the internet with a desktop computer.

At block 254, the method 250 includes monitoring consumer activity completed by the consumer based at least in part on the consumer profile information. For example, the system server 110 of FIG. 1 may monitor the consumer's internet search history, social media postings, and recent credit card transactions, as well as the consumer's digital media consumption. Digital media consumption may include a total time of consumption, a digital media type, and an amount of consumption. For example, the system server 110 of FIG. 1 may analyze the consumer activity to determine that the consumer is interested in retirement (e.g., based on internet search history, annual purchase of golf clubs, etc.), spends a majority of free time consuming digital media typically associated with retirees, and has a certain level of disposable income, based at least in part on the consumer's income and surrounding neighborhood.

Block 256 of FIG. 3 includes identifying a first lifecycle event completed by the consumer based at least in part on the consumer activity. Continuing the example above, the system server 110 of FIG. 1 may determine that the consumer recently completed a lifecycle event of having a grandchild, based on recent purchases of children's toys.

At block 258 in FIG. 3, the method 250 includes updating the consumer profile information based at least in part on the identified first lifecycle event to generate an updated consumer profile information. In FIG. 1, the system server 110 may update the consumer profile information for the consumer based at least in part on the grandchild and may generate an updated consumer profile information.

Block 260 of the method 250 includes determining a consumer category for the consumer based at least in part on the updated consumer profile information. Continuing the example, based at least in part on the updated consumer profile information, the system server 110 of FIG. 1 may determine that the consumer should be associated with a recent retiree consumer category, a grandparent category, and an over 60 year old consumer category.

At block 262, the method 250 includes selecting a first set of items to send to the consumer, based at least in part on the updated consumer profile information and the consumer category. For example, the system server 110 may select a golf course vacation, infant toys, and vitamin supplements based at least in part on the consumer's updated profile information and the associated consumer categories.

Block 264 of the method 250 includes triggering a first shipment of the first set of items to the consumer. The system server 110 of FIG. 1 may trigger a first shipment of the vacation information, toys, and vitamins to the consumer's home address.

At block 266, the method 250 includes selecting a second set of items to send to the consumer, based at least in part on the first set of items. For example, the system server 110 of FIG. 1 may select a second set of items such as children's toys, additional vitamins, and a golf course vacation to a different resort.

Block 268 of the method includes automatically triggering a second shipment of the second set of items to the consumer, wherein the second shipment is sent after a predetermined amount of time has elapsed since the first shipment. The predetermined amount of time may be based at least in part on the first lifecycle event. For example, the system server 110 of FIG. 1 may trigger the second shipment a year after the first shipment on the grandchild's birthday. The method may also include predicting a second lifecycle event the consumer will complete, wherein the second set of items is based at least in part on the predicted second lifecycle event. For example, the system server 110 may predict that the consumer will soon retire at the age of 62, and may select items accordingly.

In some embodiments, the system may aggregate consumer profile information, and present the aggregated consumer profile information to a consumer for verification of the consumer profile information. The system may categorize the consumer into one or more consumer categories based at least in part on the verified consumer profile information, and may select a first set of items for shipment to the consumer based at least in part on the one or more consumer categories. The system may trigger a first shipment of the first set of items to the consumer, and may select a second set of items for shipment to the consumer based at least in part on the first set of items and an elapsed time from the first shipment. The system may trigger a second shipment of the second set of items to the consumer. The first set of items may be selected based at least in part on a prediction of a lifecycle action the consumer will complete. The consumer profile information may include one or more of a purchase history, internet search history, or digital media consumption. The one or more consumer categories comprises an expected spend rating or an impulsiveness rating for the consumer.

It should be noted, that the method 250 may be modified in various ways in accordance with certain embodiments of the disclosure. For example, one or more operations of the method 250 may be eliminated or executed out of order in other embodiments of the disclosure. Additionally, other operations may be added to the method 250 in accordance with other embodiments of the disclosure.

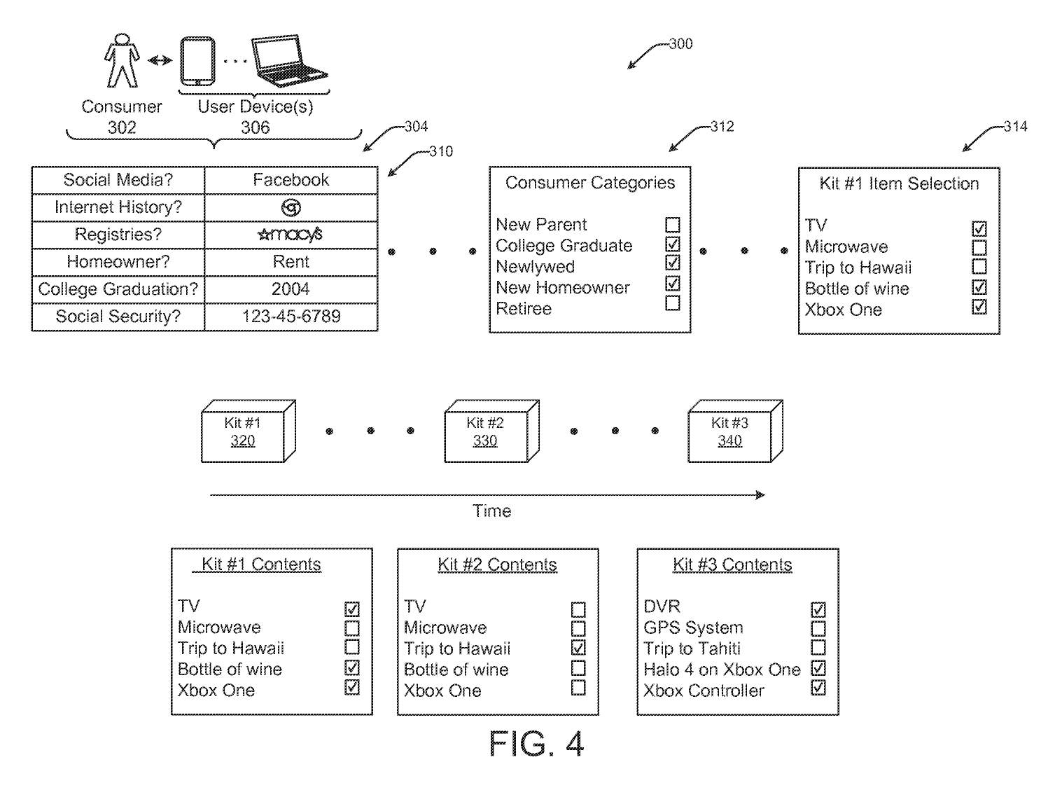

Referring now to FIG. 4, an example embodiment of a consumer 302 interacting with a user interface 304 of a user device 306 of another embodiment of the product curation system 300 is depicted. Although the user device 306 is depicted as a smartphone or tablet and a laptop computer, it is understood that the user device 306 may be any suitable device as described above. At a first screen 310 of the user interface 304 presented to the consumer 302 on the user device 306, the consumer 302 may provide personal identifiable information. Such personal identification information may include social media information, internet search history information, registry information (e.g., wedding, baby, etc.), home ownership status, college graduation status, and social security information.

The system 300 may automatically categorize the consumer 302 in one or more consumer categories based on the personal identifiable information. At a second screen 312 presented to the consumer 302, the system 300 may present the suggested consumer categories to the consumer 302 for addition or deletion of certain consumer categories. Consumer categories may include “new parent,” “college graduate,” “newlywed,” “new homeowner,” and “retiree.”

Based on the final selection of consumer categories, the system 300 may aggregate a first kit for the consumer, where the first kit includes products that are selected and/or identified as relevant to the consumer. At a third screen 314 presented to the consumer 302, the consumer may have the option to add or remove items from the selected item list. Based on the consumer's additions or deletions, the system 300 may adjust the consumer categories for the consumer.

A first kit 320 may be shipped to the consumer. The first kit 320 may include the first set of items selected for shipment to the consumer 302. At a later point in time, a second kit 330 may be shipped to the consumer 302. The second kit 330 may include a second set of items selected for shipment to the consumer 302. For example, the second kit 330 may include a honeymoon package or trip to Hawaii. The third kit 340 may include a third set of items selected for shipment to the consumer 302. The third kit 340 may be sent after a predetermined period of time, for example after the consumer has completed a game on a gaming console. The third kit 340 may include an additional gaming console controller, a new game, and a digital recording system based on the consumer's television viewing habits.

It is noted that although the user interface 304 is described in successive first, second, and third screens presented to the consumer, the screens may be presented in any order. Some embodiments may include additional or fewer screens. The depicted screens are for illustrative purposes only.

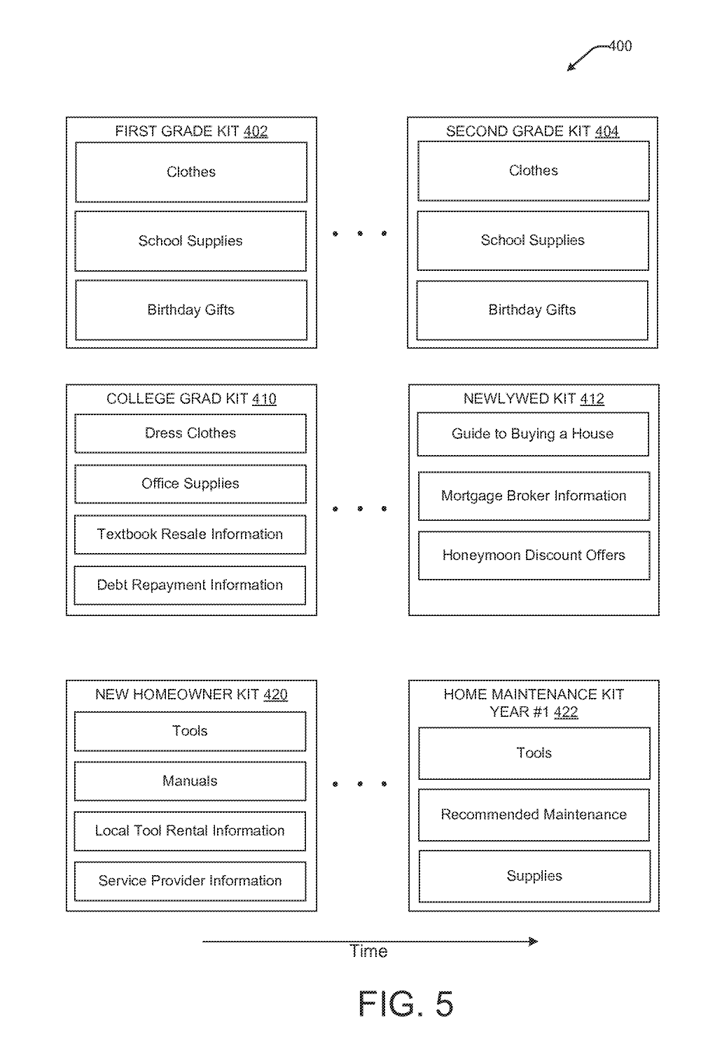

Referring now to FIG. 5, additional embodiments of lifecycle kits 400 with selected relevant products are depicted. A first grade kit 402 and a second grade kit 404 may include clothes, school supplies, and birthday gifts. The first grade kit 402 and the second grade kit 404 may be shipped a year apart. The second grade kit 404 may be automatically shipped after a predetermined time of one year has elapsed from shipment of the first grade kit 402. The clothes in the second grade kit 404, however, may be bigger than the clothes in the first grade kit 402. Additionally, the school supplies for the second grade kit 404 may include a calculator instead of stickers, in another example. Similarly, the birthday gifts for the first grade kit 402 may be age appropriate for first graders, while the birthday gifts for the second grade kit 404 may be appropriate for second graders. The birthday gifts may be an assortment of the bestselling or most desired toys for children in the selected age range. The respective kit 402, 404 may therefore provide a parent with an assortment of birthday gifts either for their own first or second grader, or for friends of their first or second grader. Because of the respective kit 402, 404, the parent may not have to search for and purchase age appropriate gifts throughout the year for their first or second grader or friends of their first or second grader.

In another example, a first college graduation kit 410 may be shipped, followed by a newlywed kit 412. The newlywed kit 412 may be shipped after the college graduation kit 410 and may be triggered, for example, by a social media post indicating an engagement. The college graduation kit 410 may include dress clothes so that the consumer is prepared for a new job, office supplies for an office or home office, and textbook resale information so the consumer can sell old textbooks. The college graduation kit 410 may also include debt repayment information to assist the consumer in repaying debt, if the consumer has debt, which can be determined based on bank statements and payments to debt servicers. The newlywed kit 412 may include information on purchasing a new home, such as books or other literature, mortgage broker information including local contacts, and honeymoon discount offers or promotions.

In another example, a new homeowner kit 420 may be followed by a first year home maintenance kit 422. The systems and methods described herein may determine the consumer recently purchased a home and may ship the new homeowner kit 420 to the consumer's new address. The new homeowner kit 420 may include basic tools, basic repair manuals or links to education videos on the internet, local tool rental information for certain tools the consumer may not own, and service provider information for local repairmen. The new homeowner kit 420 may also include information regarding other local consumers that have completed similar home improvement projects and may be available for assistance or may have tools available for use or rent. The home maintenance kit 422 may include additional tools, such that the consumer may build a collection of tools, recommended maintenance after the first year of homeownership, such as caulk sealant or grout cleaner, and supplies for completing the recommended maintenance. Subsequent kits may include updated contents or products for additional recommended time-based recommended projects.

The methods and systems described herein may result in selection and delivery of products relevant to specific consumers. Consumers may be made aware of recommended actions or may be better equipped or knowledgeable to address certain lifecycle events or goals. Consumers may receive products and items upon demand or passively. Shipments to consumers may be dynamic and contents may vary with time and consumer preferences, as well as life stage.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure, including the best mode, and to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
receiving, by a computer system comprising one or more processors, consumer profile information associated with a consumer, the consumer profile information comprising demographic information, geographic information, and social contact information;
monitoring, by the computer system, consumer activity completed by the consumer based at least in part on the consumer profile information;
identifying, by the computer system, a first lifecycle event completed by the consumer based at least in part on the consumer activity;
updating, by the computer system, the consumer profile information based at least in part on the identified first lifecycle event to generate an updated consumer profile information;
determining, by the computer system, a consumer category for the consumer based at least in part on the updated consumer profile information;
selecting, by the computer system, a first set of items to send to the consumer, based at least in part on the updated consumer profile information and the consumer category;
triggering, by the computer system, a first shipment of the first set of items to the consumer;
selecting, by the computer system, a second set of items to send to the consumer, based at least in part on the first set of items; and
automatically triggering, by the computer system, a second shipment of the second set of items to the consumer, wherein the second shipment is sent after a predetermined amount of time has elapsed since the first shipment.

2. The method of claim 1, further comprising:
predicting, by the computer system, a second lifecycle event the consumer will complete, wherein the second set of items is based at least in part on the predicted second lifecycle event.

3. The method of claim 1, wherein the predetermined amount of time is based at least in part on the first lifecycle event.

4. The method of claim 1, wherein the social contact information includes social media account information, colleague information, and professional contacts information.

5. The method of claim 1, wherein consumer activity comprises one or more of a purchase history, internet search history, or digital media consumption.

6. The method of claim 5, wherein digital media consumption comprises a time of consumption, a digital media type, and an amount of consumption.

7. The method of claim 1, wherein the consumer category comprises an expected spend rating or an impulsiveness rating.

8. The method of claim 1, wherein geographic information comprises geographic information for social contacts of the consumer.

9. A system, comprising:
at least one memory for storing computer-executable instructions;
at least one processor in communication with the at least one memory, wherein the at least one processor is configured to execute the computer-executable instructions perform a method comprising:
receiving consumer profile information associated with a consumer, the consumer profile information comprising demographic information, geographic information, and social contact information;
monitoring consumer activity completed by the consumer based at least in part on the consumer profile information;
identifying a first lifecycle event completed by the consumer based at least in part on the consumer activity;
updating the consumer profile information based at least in part on the identified first lifecycle event to generate an updated consumer profile information;
determining a consumer category for the consumer based at least in part on the updated consumer profile information;
selecting a first set of items to send to the consumer, based at least in part on the updated consumer profile information and the consumer category;
triggering a first shipment of the first set of items to the consumer;
selecting a second set of items to send to the consumer, based at least in part on the first set of items; and
automatically triggering a second shipment of the second set of items to the consumer, wherein the second shipment is sent after a predetermined amount of time has elapsed since the first shipment.

10. The system of claim 9, wherein the method further comprises:
predicting a second lifecycle event the consumer will complete, wherein the second set of items is based at least in part on the predicted second lifecycle event.

11. The system of claim 9, wherein the predetermined amount of time is based at least in part on the first lifecycle event.

12. The system of claim 9, wherein the social contact information includes social media account information, colleague information, and professional contacts information.

13. The system of claim 9, wherein consumer activity comprises one or more of a purchase history, internet search history, or digital media consumption.

14. The system of claim 13, wherein digital media consumption comprises a time of consumption, a digital media type, and an amount of consumption.

15. The system of claim 9, wherein the consumer category comprises an expected spend rating or an impulsiveness rating.

16. The system of claim 9, wherein geographic information comprises geographic information for social contacts of the consumer.

17. A method, comprising:
aggregating, by a system comprising one or more computer processors, consumer profile information;
presenting, by the system, the aggregated consumer profile information to a consumer for verification of the consumer profile information;
categorizing, by the system, the consumer into one or more consumer categories based at least in part on the verified consumer profile information;
selecting, by the system, a first set of items for shipment to the consumer based at least in part on the one or more consumer categories;
triggering, by the system, a first shipment of the first set of items to the consumer;
selecting, by the system, a second set of items for shipment to the consumer based at least in part on the first set of items and an elapsed time from the first shipment; and
triggering, by the system, a second shipment of the second set of items to the consumer.

18. The method of claim 17, wherein the first set of items is selected based at least in part on a prediction of a lifecycle event the consumer will complete.

19. The method of claim 17, wherein the consumer profile information comprises one or more of a purchase history, internet search history, or digital media consumption.

20. The method of claim 17, wherein the one or more consumer categories comprises an expected spend rating or an impulsiveness rating for the consumer.
